(19) United States
(12) Patent Application Publication
(10) Pub. No.: US 2008/0282244 A1
(43) Pub. Date: Nov. 13, 2008

(54) Distributed transactional deadlock detection

(75) Inventors: Ming-Chuan Wu, Bellevue, WA (US); Yuxi Bai, Kirkland, WA (US); Robert H. Gerber, Bellevue, WA (US); Alexandre Verbitski, Woodinville, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/800,675

(22) Filed: May 7, 2007

(51) Int. Cl. G06F 9/46

(52) U.S. Cl. 718/100

(57) ABSTRACT

Aspects of the subject matter described herein relate to deadlock detection in distributed environments. In aspects, nodes that are part of the environment each independently create a local wait-for graph. Each node transforms its local wait-for graph to remove non-global transactions that do not need resources from multiple nodes. Each node then sends its transformed local wait-for graph to a global deadlock monitor. The global deadlock monitor combines the local wait-for graphs into a global wait-for graph. Phantom deadlocks are detected and removed from the global wait-for graph. The global deadlock monitor may then detect and resolve deadlocks that involve global transactions.

### BACKGROUND

A deadlock may occur when two or more processes are involved in attempting to lock shared resources. In a deadlock, there is a cyclical wait among the processes involved. Each of the processes is waiting for at least one resource that another of the processes has locked. When a deadlock occurs, if nothing else is done or occurs to break the deadlock, none of the processes involved in the deadlock may be able to complete its work.

### SUMMARY

Briefly, aspects of the subject matter described herein relate to deadlock detection in distributed environments. In aspects, nodes that are part of the environment each independently create a local wait-for graph. Each node transforms its local wait-for graph to remove non-global transactions that do not need resources from multiple nodes. Each node then sends its transformed local wait-for graph to a global deadlock monitor. The global deadlock monitor combines the local wait-for graphs into a global wait-for graph. Phantom deadlocks are detected and removed from the global wait-for graph. The global deadlock monitor may then detect and resolve deadlocks that involve global transactions.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” should be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary general-purpose computing environment into which aspects of the subject matter described herein may be incorporated;

FIG. 2 is a block diagram that generally represents an exemplary environment in which aspects of the subject matter described herein may operate;

FIG. 3 is a block diagram that generally represents components that may be used to detect deadlock in a distributed system according to aspects of the subject matter described herein;

FIG. 4, which is a block diagram illustrating a phantom deadlock in accordance with aspects of the subject matter described herein;

FIG. 5 is a block diagram that generally represents exemplary actions that may occur in creating a transformed local wait-for graph in accordance with aspects of the subject matter described herein; and

FIG. 6 is a block diagram that generally represents actions that may occur at a global deadlock detector to detect deadlock for global transactions.

### DETAILED DESCRIPTION

### Exemplary Operating Environment

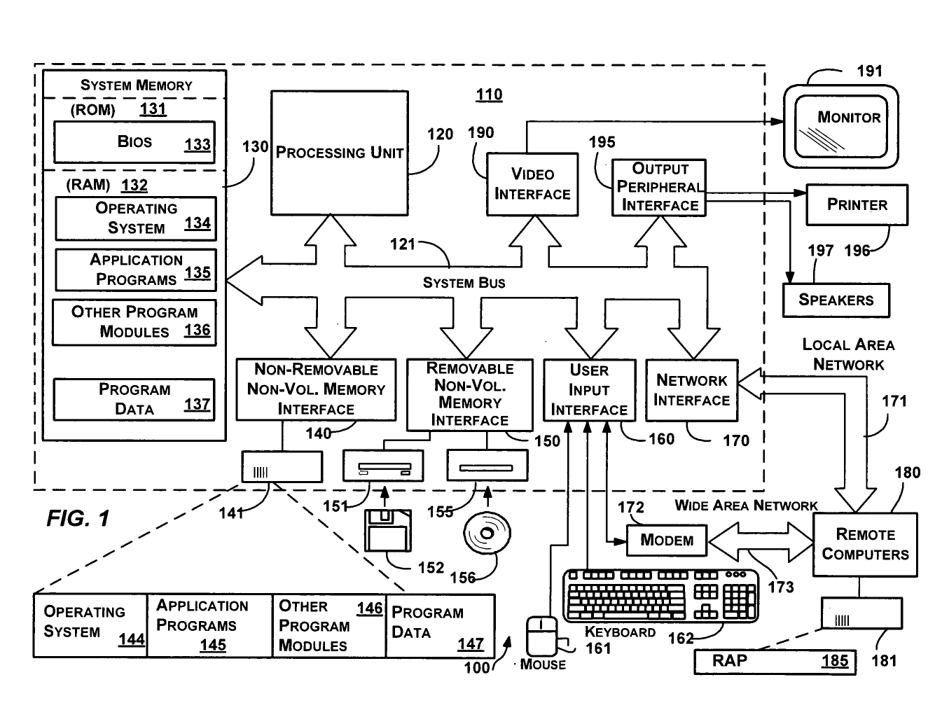

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 110. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, a touch-sensitive screen of a handheld PC or other writing tablet, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Distributed Deadlock Detection

As mentioned previously, deadlock may cause a set of processes to block endlessly while waiting for resources to become free. One mechanism for dealing with deadlock is to detect when deadlock has occurred and to then take actions to break the detected deadlock.

Deadlock detection in distributed systems poses several challenges. One challenge is communication costs incurred to obtain a global knowledge of wait-for relations in order to find distributed cyclical waits. Another challenge is obtaining a consistent wait-for graph (WFG) to determine deadlock. Obtaining a consistent wait-for graph may involve suspending all the nodes of a system while taking a snapshot of local WFGs. As yet another challenge, if there is not synchronization between local and global deadlock mechanisms, phantom deadlocks (i.e., situations that look like deadlock but are not) may be identified more frequently. As will be readily recognized, many approaches to gather information to detect deadlock on distributed systems may cause an unacceptable impact on concurrency and performance. Aspects of the subject matter described herein are directed to addressing the challenges above and others.

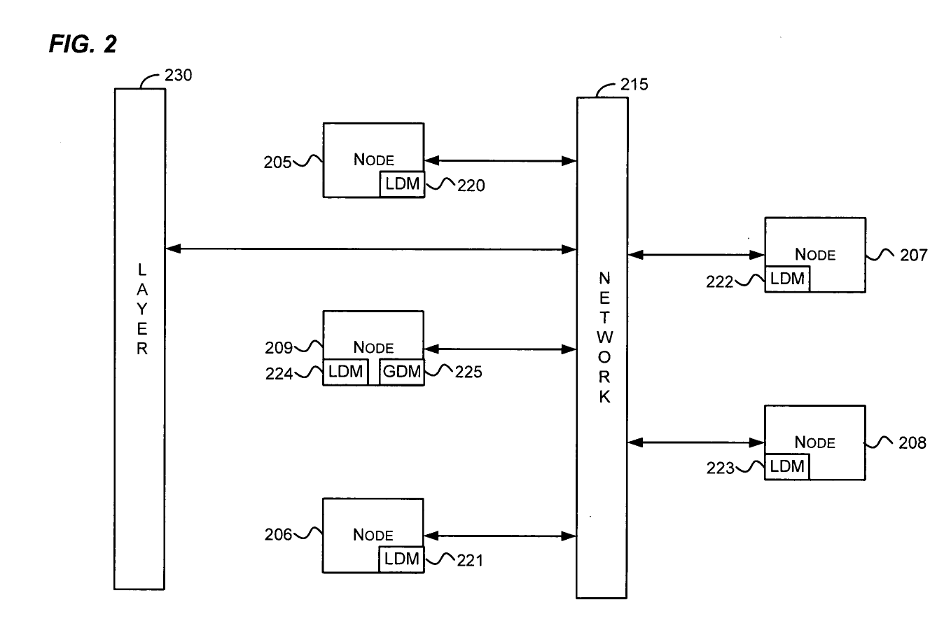

FIG. 2 is a block diagram that generally represents an exemplary environment in which aspects of the subject matter described herein may operate. The environment includes nodes 207-209, network 215, and a layer 230. The nodes 205-208 include local deadlock monitors (LDMs) 220-224, respectively, while the node 209 includes a global deadlock monitor (GDM) 225. In another embodiment, a node may include a GDM without including an LDM.

The network 215 represents any mechanism and/or set of one or more devices for conveying data from one node to another and may include intra- and inter-networks, the Internet, phone lines, cellular networks, networking equipment, direct connections between devices, wireless connections, and the like.

In one embodiment, the nodes 205-209 include computers. An exemplary computer 110 that is suitable as a node is described in conjunction with FIG. 1. In another embodiment, the nodes 205-209 may include any other device that is capable of locking resources for exclusive or shared use in a computing environment. In one embodiment, a node may comprise a set of one or more processes that may request an exclusive or shared lock of one or more resources. In one embodiment, a resource comprises a chunk of data stored, for example, in a database, file system, main memory, or the like. In another embodiment, a resource comprises any physical or virtual component of limited availability within a node or set of nodes.

The terms processes, tasks, and worker threads are used herein to denote a mechanism within a computer that performs work. A task may be performed by one or more processes and/or threads. Where the term process is used it is to be understood that in an alternative embodiment the word thread may also be substituted in place of the term process. Where the term thread is used it is to be understood that in an alternative embodiment the word process may also be substituted in place of the term process.

In one embodiment, the nodes 205-209 may be configured with database management system (DBMS) software. Each node's DBMS software may store and access data on computer-readable media accessible by the node. The nodes may be accessed via a layer 230 that makes the databases on the nodes appear as one database to outside entities. The layer 230 may be included on an entity that seeks to store or access the data on-the nodes, on a node intermediate to the nodes 205-209, on one or more of the nodes 205-209 themselves, on some combination of the above, and the like. The layer 230 may determine where to store and access data on the nodes 205-209 and may work in conjunction with any DBMS software included on the nodes. Placing the layer 230 between the nodes and external entities may be done, for example, to increase resource availability, performance, redundancy, and the like.

In one embodiment, each of the nodes 205-209 has its own processor(s), memory space, and disk space. In this embodiment, the network 215 is a shared resource among the nodes 205-209. In other embodiments, aspects of the subject matter may also be applied to nodes that share resources other than the network 215. For example, one or more of the nodes 205-209 may reside on a single physical machine and may share processor(s), memory, space, disk space, and/or other resources. As another example, two or more instances of a DBMS may execute on a single node and apply aspects of the subject matter described herein to detect deadlock for global transactions.

A transaction may be carried out by multiple processes. There are two types of transactions: local transactions (whose processes are local to a single node) and global transactions (whose processes are distributed among multiple nodes). Local deadlocks at a single node concern processes on the single node. Distributed deadlocks concern global transactions.

Each of the LDMs (e.g., LDMs 220-224) may be employed to detect deadlock that involve resources from a single node. For example, if two or more processes on a single node are deadlocked regarding a resource belonging to the node, an LDM on the node may periodically scan for local deadlocks and detect the deadlocked processes. The LDM may then employ any appropriate resolution process (e.g., killing one of the processes) to break the deadlock.

The GDM 225 may be employed to detect deadlock for transactions that span resources on two or more nodes as described in more detail below. After detecting a deadlock, the GDM 225 may work in conjunction with the LDMs involved with the nodes to resolve the deadlock by, for example, killing one or more processes involved in the deadlock.

In accordance with aspects of the subject matter described herein, periodically and independently from each other, each LDM attempts to determine processes that are blocked and waiting for other processes to release resources. In doing this, an LDM may create a dependency graph, for example, where cycles may represent local deadlock. In other embodiments, the dependency graph may use mechanisms other than cycles to represent local deadlock. After making this determination, an LDM then removes all tasks from this graph that are waiting for local resources (e.g., tasks that are not involved in a global transaction involving resources on one or more other nodes) to create a transformed local wait-for graph.

A task of a first transaction, where the task is executing on a first node, may be waiting for a resource locked by another task of a second “inactive” transaction. An inactive transaction on the node is one that has finished all its operations on that node, but is still holding on to (i.e. locking) all the resources it requested during the operation. An inactive transaction may be waiting for all its other tasks on other nodes to finish before it releases the resource(s) it is holding on the first node. In this case, in transforming the local wait-for graph, the LDM does not remove the indication in the graph of the first transaction waiting on the second transaction.

The LDM then sends the transformed local wait-for graph to the GDM 225. Periodically and independently from the LDMs, The GDM 225 combines the graphs from each of the LDMs into a global wait-for graph. The GDM then identifies deadlocks via the global wait-for graph. After identifying deadlocks, the GDM 225 attempts to remove phantom deadlocks. After identifying and disregarding the phantom deadlocks, the GDM 225 may then engage in deadlock resolution.

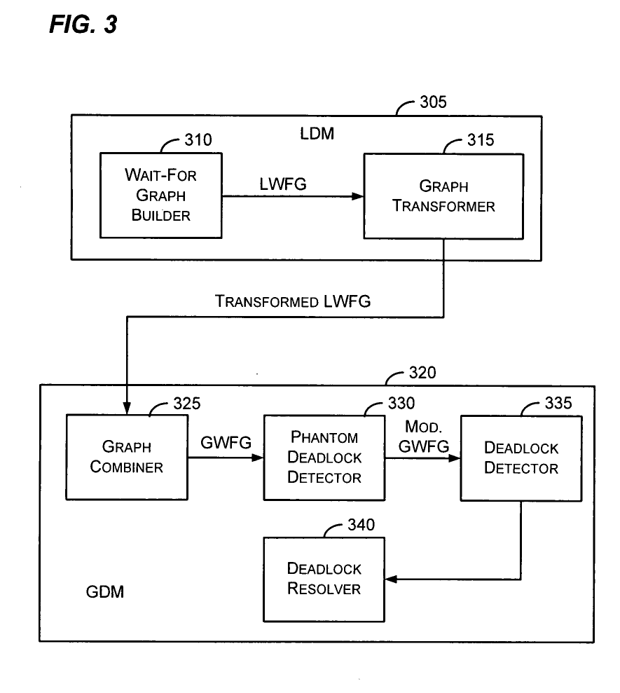

This process may be represented more formally by referring to FIG. 3 and the text below. FIG. 3 is a block diagram that generally represents components that may be used to detect deadlock in a distributed system according to aspects of the subject matter described herein. In FIG. 3, an LDM 305 includes a wait-for graph builder 310 and a graph transformer 315. The LDM 305 sends a transformed local wait for graph (LWFG) to a graph combiner 325 of a global deadlock detector (e.g., GDM 320). Although not shown, in practice there may be many LDMs that provide transformed LWFGs to the GDM 320. These LDMs would operate similarly to the LDM 305.

The graph combiner 325 combines graphs from each LDM that has sent a LWFG and then passes the combined graph through a phantom deadlock detector 330. The phantom deadlock detector 330 removes phantom deadlocks and passes a modified global wait-for graph to a deadlock detector 335. The deadlock detector 335 detects deadlocks in the modified global wait-for graph and passes information about global transactions that are deadlocked to a deadlock resolver 340 that resolves the deadlocks as appropriate.

More formally this process may be represented using the following notation, where:

Tᵢ is a worker thread i on a node;

Tᵢ→Tⱼ denotes an edge from Tᵢ to Tⱼ indicating a wait-for dependency from Tᵢ to Tⱼ (i.e., worker thread Tᵢ waits for Tⱼ to release a resource);

WFG is a collection of vertices and edges. A vertex is associated with a specific transaction. WFG={V, E}, where V={v|v is a worker thread participating in any wait-for relation} and E={e_{i,j}|e_{i,j} denotes a wait-for relation, or an edge, from vᵢ→v_{j};}

Xᵢ denotes a global transaction in the distributed system;

∥Xᵢ∥ denotes the set of nodes on which the global transaction Xᵢ is running;

Nodeᵢ denotes a node with ID i;

T_{i,j} denotes the jₜₕ worker thread of the global transaction Xᵢ. Note that this notation does not specify on which node the work thread is running;

T_{Li} denotes the i-th local worker thread;

LDMA denotes a local deadlock monitor agent that is in charge of transforming a LWFG for use by a global deadlock monitor;

LDM denotes a local deadlock monitor;

GDM denotes a global deadlock monitor; and

LWFGᵢ denotes a local wait-for graph from Nodeᵢ.

In one embodiment, the following actions may occur as part of the transformation of the LWFG:

1. All tasks that are not part of a global transaction are removed. For example, T_{i,j}→T_{L1}→T_{L2}→T_{k,n} is reduced to T_{i,j}→T_{k,n}.

2. Any path that ends locally is eliminated. For example, paths such as T_{i,j}→T_{L1} and Tᵢⱼ→NULL are removed.

3. All tasks that are part of a global transaction are replaced by their corresponding global transaction IDs, e.g., T_{i,j}→T_{L1}→T_{L2}→T_{k,n}→Tᵢₘ becomes Xᵢ→Xₖ→Xᵢ.

In another embodiment, a process that transform a LWFG for use by a GDM may take as input a LWFG that contains all blocked tasks on the node after having resolved all local deadlocks. LWFG is defined as a set of {V, E}, where V is a set of vertices, and E is a set of edges. This LWFG may be obtained from the local deadlock monitor (LDM) at the end of the LDM cycle, for example. After receiving this LWFG, the process may perform the following actions:

1. Reduce the LWFG by applying the following reduction rules iteratively until no further reduction is possible where the reduction rules below are specified in terms of edges (e) in the LWFG:

a. ∀eεLWFG in the form T_{i,j}→T_{m,n} where either i=m or i≠m, LWFG^{r} (reduced LWFG)=LWFG−e if and only if T_{m,n}∉V_{source} (the set of all vertices in LWFG that are the source vertices of some edge in LWFG). LWFG−e is defined as {V′, E′} where E′=E−{e}, and V′=V−V^{e}. V^{e} denotes the set of vertices whose in-degree and out-degree are both zero.

b. ∀eεLWFG in the form T_{i,j}→T_{EXT} (T_{EXT} represents the aggregate of all tasks on other nodes by which tasks on this node may be blocked), LWFG^{r}=LWFG.

c. eεLWFG in the form T_{i,j}→Lₖ, LWFG^{r}=LWFG−e if and only if Lₖ∉V_{source}.

d. ∀eεLWFG in the form L_{k→T}_{i,j}, LWFG^{r}=LWFG−e if and only if Lₖ∉V_{dest} (the set of all vertices in LWFG that are the destination vertices of some edge in LWFG) or T_{i,j}∉V_{source}.

e. ∀eεLWFG in the form Lᵢ→Lⱼ, LWFG^{r}=LWFG−e if and only if Lᵢ∉V_{dest} or Lⱼ∉V_{source}.

Implicitly, a vertex is removed from the wait-for graph when its indegree (i.e., number of incoming edges) is 0 and outdegree (i.e., number of outgoing edges) is also 0.

2. Translate local task ID to global transaction ID and construct a new wait-for graph in which vertices correspond to global transaction IDs. Translation is accomplished by simply replacing T_{i,j}with Xᵢ in LWFG^{r}. Local tasks that do not belong to any global transactions remain unchanged. LWFG^{rt} denotes the newly construction LWFG post translation. The table below lists the translations for edges of different forms.

| Before Translation | After Translation |
|---|---|
| T_{i,j}→T_{m,n} | Xᵢ→Xₘ |
| T_{i,j}→T_{i,k} | Xᵢ→Xᵢ (actual edge is |
| | omitted from LWFG^{rt}) |
| T_{i,j}→T_{EXT} | Xᵢ→ T_{EXT} |
| T_{i,j}→Lₖ | Xᵢ→ Lₖ |
| Lₖ→T_{i,j} | Lₖ→ Xᵢ |
| Lᵢ→Lⱼ | Lᵢ→Lⱼ |

3. Reduce LWFG^{rt} by applying the following reduction rules (reduction rules specified in terms of vertices in LWFG^{rt})

a. ∀vεLWFG where v≠T_{EXT} and indegree(v)=0, LWFG^{rtr}=LWFG^{rt}−v, where LWFG^{rt}−v is defined as {V′, E′} where V′=V−{v}, and E′=E−E^{v}. E^{v} denotes the set of edges which have v as either its source vertex or its destination vertex.

b. ∀vεLWFG^{rt} where v≠T_{EXT} and outdegree(v)=0, LWFG^{rtr}=LWFG^{rt}−v.

c. ∀vεLWFG^{rt} where v is in the form Xᵢ, and ∃T_{i,j}εXᵢ such that T_{i,j} is not blocked, LWFG^{rtr}=LWFG^{rt} −v.

LWFG^{rtr} denotes the LWFG^{rt} after reduction. Implicitly, when a vertex is removed from the wait-for graph, all of its incoming and outgoing edges are also removed from the graph.

4. Construct edge list, E_{GDM}, to be sent to the global deadlock monitor (GDM). Construction of E_{GDM} proceeds as follows:

a. E_{GDM}=Ø.

b. ∀eεLWFG^{rtr} in the form Xᵢ→Xⱼ, E_{GDM}=E_{GDM}+e.

c. ∀eεLWFG^{rtr} in the form Xᵢ→T_{EXT}, E_{GDM}=E_{GDM}+e.

d. ∀eεLWFG^{rtr} in the form Xᵢ→Lₖ, find all of Xᵢ's nearest successors (via partial depth-first search or partial breath-first search, for example) that are either in the form Xⱼ where j≠i or T_{EXT}, create new edges in the form Xᵢ→Xⱼ or Xᵢ→T_{EXT}, and add these new edges to E_{GDM}. Note that all intermediate node-local tasks in the form Lₖ on the paths from Xᵢ to Xⱼ or from Xᵢ to T_{EXT} are omitted. Note also that these new edges may not exist in LWFG^{rtr}.

e. Remove duplicate edges from E_{GDM}.

5. Send E_{GDM} to GDM.

Whenever an LDM sees a task waiting for a non-local resource (sometimes called a “network resource”), the LDM records the wait-for relation with a predefined surrogate blocking task (e.g., T_{EXT} as described above). The LDM has no need to explore wait-for relations across node boundaries. Thus, no extra communication costs need to be incurred. Neither is a global lock manager needed to prevent deadlocks.

After the above transformation, each LDMA sends its transformed LWFG to the GDM 320. The GDM 320 maintains a buffer for each LDMA to keep the most recent LWFG for the corresponding node. If the buffer for a node is empty, the GDM 320 may assume that the transformed LWFG is empty for that node. The GDM 320 deadlock detection cycle may start at its own pace. There needs to be no synchronization point between GDM and the LDMs. The GDM may construct the GWFG from the buffered LWFGs as follows:

1. Construct the GWFG as the union of the all transformed LWFGs;

2. Determine the set of unblocked transactions, U, to avoid phantom deadlocks (by counting any Xₖ's appearance in LWFGᵢ). For each Xₖ ε GWFG vertices, if ∃Nodeᵢε∥Xₖ∥ such that Xₖ∉ transformed LWFGᵢ, then add Xₖ to U. ∥Xₖ∥ may be produced or maintained in various ways. In one embodiment, a global registry may track at which nodes a given transaction is active. Alternately, in another embodiment, the data structure (LWFGᵢ) sent to the GDM from each Nodeᵢ may include a list including each Nodeⱼ where a transaction has been or is active;

3. Reduce GWFG={V, E} by recursively removing the unblocked transactions starting with the transactions in U (i.e., the transitive closure of U based on the wait-for relation)

a. If U is not empty, select and remove an Xᵢ from U;

b. Remove Xᵢ from the set of vertices of GWFG; remove all edges from the set of edges of GWFG where either it is an incoming edge to Xᵢ or it is an outgoing edge from Xᵢ;

c. Add any transaction Xⱼ to the set U, if Xᵢ becomes unblocked because of the removal of Xᵢ from GWFG; and

d. Repeat a-c until U is empty.

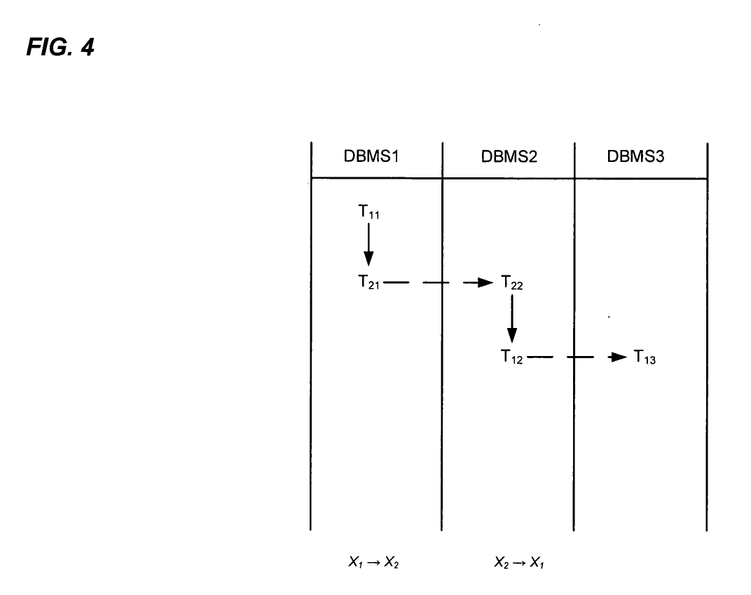

Step 2 above may be better understood by referring to FIG. 4, which is a block diagram illustrating a phantom deadlock in accordance with aspects of the subject matter described herein. In FIG. 4, three DBMSs (e.g., DBMS1, DBMS2, and DBMS3) are shown as well as two transactions (e.g., X₁ and X₂) that together span the DBMSs.

The solid lines between transaction tasks represent that a transaction task is waiting for another transaction task. For example, transaction task T₁₁ is waiting for T₂₁ and T₂₂ is waiting for T₁₂. The dotted lines between tasks indicate an implicit wait. In an implicit wait, a task knows that it is waiting for a resource from a network to become available, but the blocker that has locked the resource does not know about the waiter or the wait-for relation. When a GWFG is constructed for the transactions, it appears that a transaction including a task to the left of an arrow is waiting on a transaction including a task to the right of the arrow. For example, the GWFG would indicate that a task of X₁ is waiting on a task of X₂ while a task of X₂ is waiting on a task of X₁.

However, by examining the information shown in FIG. 4, it can be seen that T₁₃ is not waiting on any task and will under normal circumstances be able to complete. After T₁₃ completes, T₁₂ can complete after which T₂₂ can complete and so forth. So the transactions X₁ and X₂ are not in deadlock but because of the way that the GWFG is constructed, it appears that they are. This is what has previously been described as a phantom deadlock.

A GDM may detect this phantom deadlock in at least two ways. First, if the GDM knows or is made aware that one of the processes in one of the transactions is not waiting, it may remove arrows that originate from the transaction.

Second, the LDMs may report to the GDM the number of tasks involved in the transactions and where the tasks are executing. In the example shown in FIG. 4, the transaction X₁ has three tasks which are executing on all three of the DBMSs, while the transaction X₂ has two tasks that are executing on DBMS1 and DBMS2. When DBMS3 reports its transformed LWFG to the GDM, the GDM may determine that the task T₁₃ is not waiting on any other task. This may be determined since the DBMS3 will not include a wait-for relation for transaction X₁ in the transformed LWFG it sends to the GDM. At this point, the GDM may remove any outgoing arrows from T₁₃'s corresponding transaction (i.e., X₁). When these arrows are removed, it can be seen that there is no deadlock between transaction X₁ and X₂ .

As another check, information may be kept about the progress of a transaction. For example, each time a task of a transaction is blocked by a different process and enters a wait state, a counter may be incremented regarding the transaction. The idea is that as long as a transaction is making progress it is not blocked.

In one embodiment, this information is used before killing a process in the deadlock resolution phase. If the process has made progress since the last deadlock detection cycle, the process is not killed. In other embodiments, this information may be used to further transform the LWFG to exclude transactions that have made progress from last reporting or the information may be used in the GDM to remove edges in the GWFG. For example, any transaction that has made progress may have outgoing edges removed.

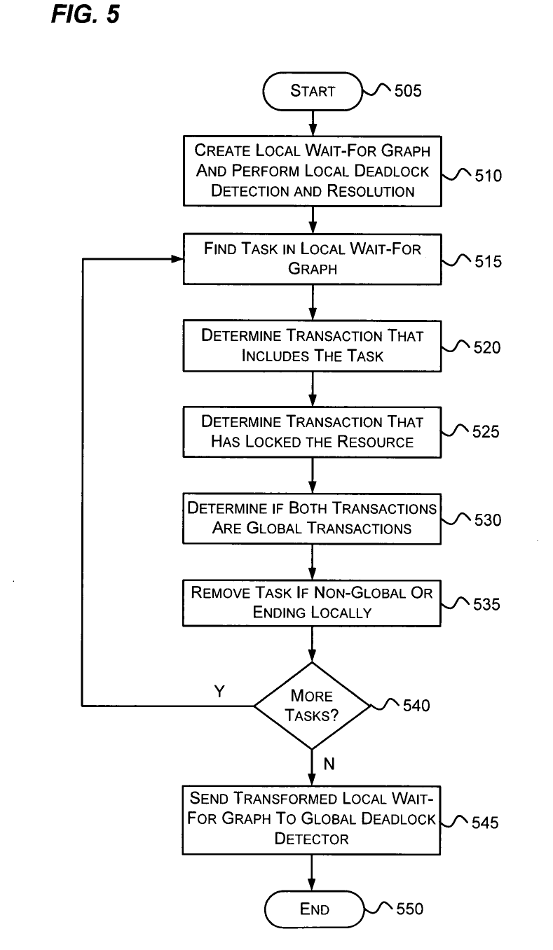

FIG. 5 is a block diagram that generally represents exemplary actions that may occur in creating a transformed local wait-for graph in accordance with aspects of the subject matter described herein. At block 505, the actions begin.

At block 510, a local wait-for graph is created and local deadlock detection and resolution are performed. This may be done as described previously by a local deadlock detector, for example. For example, referring to FIG. 2 LDM 221 may create a wait-for graph for tasks executing on the node 206. Thereafter, the graph may be reduced to remove local tasks that are not involved in a deadlock. In one embodiment, This may be done by the following steps for every edge:

1. If the edge's source vertex is not participating in a deadlock, remove the edge.

2. If the edge's destination vertex is not participating in any deadlock, remove the edge.

3. If the vertex has zero incoming edges or zero outgoing edges, remove the vertex from the graph.

Repeat steps 1-3 above until no additional edges or vertices can be removed from the graph.

With this graph, local deadlocks may be detected and resolved. After local deadlocks are resolved, the LWFG may be updated to remove all previously blocked processes that have become unblocked or have been aborted as a result of resolving local deadlocks.

If the graph is empty at this point, the actions may end or the GDM may be notified that no tasks are in deadlock on the node. Otherwise, the actions associated with blocks 515-545 may be performed.

At block 515-540, the tasks in the LWFG are iterated on to create a transformed LWFG that includes tasks involved in global transactions. At block 515, a task in the LWFG is selected. At block 520, the transaction that includes the task is determined. This may be done via a look-up table that associates tasks with transactions for example.

At block 525, a transaction that has a task that has blocked the first task is determined. At block 530, a determination is made as to whether both transactions are global. At block 535, the first task is removed if it is non-global or depends on a task that is non-global (e.g., a task that is executing locally).

At block 540, a determination is made as to whether there are more tasks to iterate on in the local wait-for graph. If so, the actions continue at block 540; if not, the actions continue at block 545.

By block 545, a transformed LWFG has been created by removing tasks that are not part of a global transaction and paths that end locally or via the other process described in conjunction with FIG. 3 above. In addition, task IDs in the graph have been replaced with their corresponding global transaction IDs. At block 545, the transformed LWFG is sent to a global deadlock detector. At block 550, the actions end. The actions described above with respect to FIG. 5 may be performed on the various nodes and may be performed periodically and independently by each node as described previously.

In another embodiment, the actions associated with blocks 515-540 may be replaced with other actions which include:

1. Remove from the LWFG vertices for local tasks that do not belong to a global transaction;

2. Translate task IDs of the remaining processes into their corresponding global transaction IDs;

3. Remove edges whose source and destination vertices have the same global transaction ID;

4. Remove duplicate edges;

5. Locally, mark a global transaction as safe (i.e., not participating in any deadlock) if and only if at least one of the local tasks that belongs to that global transaction is safe; and

6. Reduce the modified LWFG using the set of locally safe global transactions computed in step 5 following the same reduction rules used for reducing the local wait for graph as described previously in conjunction with block 510.

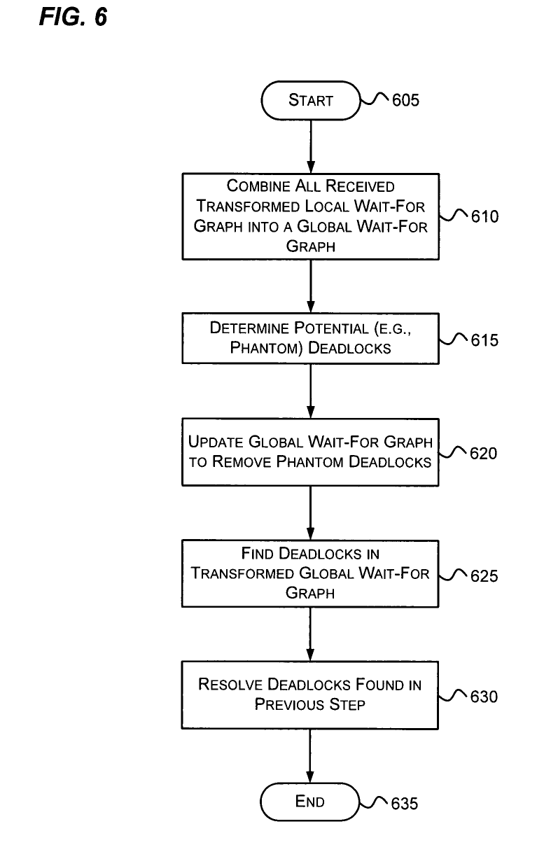

FIG. 6 is a block diagram that generally represents actions that may occur at a global deadlock detector to detect deadlock for global transactions. A transaction is a global transaction if it needs resources from at least two nodes to complete. At block 605, the actions begin.

At block 610, all transformed local wait-for graphs are combined in a global wait-for graph. This combination may occur as each LWFG is sent to a global deadlock monitor and does not need to be performed all at once. Indeed, a GWFG may be maintained and be updated each time a LWFG is received, at some periodic time irrespective of when LWFGs are received, or some combination of the above.

At block 615, potential deadlocks are determined as described previously. For example, referring to FIG. 3, the deadlock detector 335 may detect deadlocks in the GWFC.

At block 620, the GWFG is updated to remove edges that would indicate deadlock for a phantom deadlock. For example, if it is determined that a transaction needs resources from more nodes than have reported that the transaction is blocked on, edges from the transaction may be removed from the GWFG. Another way of saying this is that a global transaction is not blocked if and only if at least one of its tasks on any node is not blocked.

At block 625, cycles in the GWFG are detected to determine deadlocked global transactions. For example, referring to FIG. 3, the deadlock detector 335 identifies deadlocks in the GWFG.

At block 630, deadlocks are resolved as appropriate as described previously. For example, referring to FIG. 3, the deadlock resolver 340 determines how to resolve deadlocks and involves the nodes having deadlocked transactions as appropriate.

At block 635, the actions end.

As can be seen from the foregoing detailed description, aspects have been described related to detecting deadlock in a distributed environment. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A computer-readable medium having computer-executable instructions, which when executed perform actions, comprising:
determining a first task that is waiting for a resource to become available;
determining a first transaction that includes the first task, the first transaction having tasks executing on a plurality of nodes, the first task executing on a first node;
determining a second transaction that includes a second task that has locked the resource, the second transaction having tasks executing on a plurality of nodes, the second task executing on the first node, the second task waiting for a third task to complete, the third task executing on a second node;
creating a data structure that indicates that at least one task of the first transaction is waiting for a resource locked by at least one task of the second transaction; and
sending the data structure to a global deadlock detector.

2. The computer-readable medium of claim 1, wherein determining a first task that is waiting for a resource to become available comprises creating a wait-for graph for resources local the first node, the wait-for graph indicating tasks that are waiting for other tasks to release resources.

3. The computer-readable medium of claim 2, wherein creating a wait-for graph is performed by a deadlock detection mechanism of the first node.

4. The computer-readable medium of claim 1, wherein each of the pluralities of nodes comprises nodes that do not share main memory, disk-space, or processors.

5. The computer-readable medium of claim 1, wherein each of the pluralities of nodes executes a different instance of database management system software and wherein the first and second transactions involve data that spans at least two of the instances.

6. The computer-readable medium of claim 1, wherein at least one of the pluralities of nodes includes virtual nodes hosted on one or more virtual servers.

7. The computer-readable medium of claim 1, wherein determining a first task that is waiting for a resource to become available comprises creating a wait-for graph for detecting deadlock on a the first node and removing information in the wait-for graph for tasks that are not part of a global transaction.

8. The computer-readable medium of claim 7, wherein determining a first task that is waiting for a resource to become available further comprises removing any path in the wait-for graph where a task is waiting for a resource on the first node.

9. The computer-readable medium of claim 1, further comprising removing an indication from the data structure that at least one task of the first transaction is waiting for a resource locked by at least one task of the second transaction if there exists a task of the first transaction that is not blocked.

10. The computer-readable medium of claim 1, further comprising removing an indication from the data structure that at least one task of the first transaction is waiting for a resource locked by at least one task of the second transaction if any of the tasks that are part of the first or second transaction that are executing on the first node is not waiting for a resource to become available.

11. A method implemented at least in part by a computer, the method comprising:
constructing a wait-for graph for a first set of transactions from information received from at least two nodes, the information indicating a first transaction that is waiting for a resource to become available on one of the at least two nodes, the resource locked by a task of a second transaction, the first and second transactions needing resources on the at least two nodes to complete, each of the at least two nodes being free to create and send its portion of the information independently of any other of the at least two nodes; and
determining, from the wait-for graph, a second set of transactions that are potentially in deadlock.

12. The method of claim 11, further comprising determining a third set of transactions that are not blocked, the second set of transactions including the transactions in the third set of transactions.

13. The method of claim 12, further comprising and removing edges from the wait-for graph where an edge goes to or comes from a transaction in the third set of transactions.

14. The method of claim 13, further comprising removing any edge that goes to or comes from a transaction that become unblocked by removing edges from the wait-for graph in claim 13.

15. The method of claim 11, further comprising tracking progress of the first transaction and refraining from killing a task of the first transaction if the first transaction has progressed after it was waiting for the resource.

16. The method of claim 11, wherein the information received from at least two nodes comprises, for each of the at least two nodes, a local wait-for graph that is created by its respective node without consulting any other of the at least two nodes to try to determine if a transaction on either of the at least two nodes is deadlocked, the local wait-for graph indicating transactions that are waiting for external resources to become available.

17. The method of claim 11, further comprising refraining from killing a task of the first transaction if it is determined that the transaction is making progress.

18. In a computing environment, an apparatus, comprising:
a graph combiner operable to combine wait-for graphs received from a plurality of nodes into a global wait-for graph;
a phantom deadlock detector operable to update the global wait-for graph by removing edges for transactions that are not in deadlock; and
a deadlock detector operable to detect deadlocks in the global wait-for graph.

19. The apparatus of claim 18, further comprising a deadlock resolver operable to kill at least one task involved in a deadlock to resolve the deadlock.

20. The apparatus of claim 18, further comprising a graph transformer operable to remove non-global transactions from a local wait-for graph.
